(19) United States
(12) Patent Application Publication
(10) Pub. No.: US 2005/0140584 A1
(43) Pub. Date: Jun. 30, 2005

(54) Method and apparatus for driving plasma display panel

(75) Inventors: Hwan Yu Kim, Uiwang-si (KR); Dae Jin Myoung, Goyang-si (KR); Geun Soo Lim, Seongnam-si (KR); Jun hak Lee, Suwon-si (KR); Jung Hwan Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/010,323

(22) Filed: Dec. 14, 2004

(30) Foreign Application Priority Data
Dec. 16, 2003 (KR) 10-2003-0091783

(51) Int. Cl. G09G 3/28

(52) U.S. Cl. 345/60

(57) ABSTRACT

Disclosed herein is a method and apparatus for driving a plasma display panel in which signal distortion can be minimized while reducing contour noise. According to the present invention, the method of driving the plasma display panel includes the steps of performing a first inverse gamma correction operation on externally inputted video data, performing a confined error diffusion operation on the first inverse gamma corrected video data within a range of a dither mask pattern of an upper gray scale, dithering the confined error diffused video data by using a plurality of dither mask patterns which are separated every gray scale and every frame, performing a second inverse gamma correction operation on the dithered video data, and mapping the second inverse gamma corrected video data to a sub-field pattern in which one frame includes one or more selective writing sub-fields and one or more selective erasing sub-fields.

This Nonprovisional application claims priority under 35 U.S.C. § 119(a) on Patent Application No. 10-2003-0091783 filed in Korea on Dec. 16, 2003, the entire contents of which are hereby incorporated by reference.

### BACKGROUND OF THE INVENTION

1. Field of the Invention

The present invention relates to a method and apparatus for driving a plasma display panel, and more particularly, to a method and apparatus for driving a plasma display panel in which signal distortion can be minimized while reducing contour noise.

2. Description of the Background Art

A plasma display panel (hereinafter, referred to as PDP), which can be easily made large, has attracted public attention as a flat panel display device. The PDP is adapted to display an image by controlling a gas discharge period of each of pixels according to digital video data. A representative PDP is one, which has three electrodes and is driven with an AC voltage, as shown in FIG. 1.

FIG. 1 is a perspective view illustrating the structure of a discharge cell of a conventional three-electrode AC surface discharge type PDP.

Referring to FIG. 1, the discharge cell of the PDP includes a pair of sustain electrodes 12A, 12B formed on the bottom surface of an upper substrate 10, and a data electrode 20 formed on the top surface of a lower substrate 18.

Each of the pair of the sustain electrodes 12A, 12B has a dual layer structure of transparent electrodes and metal electrodes. The sustain electrode pair 12A, 12B include a scan electrode 12A which receives a scan signal for an address discharge and a sustain signal for a sustain discharge as an input, and a sustain electrode 12B which receives a sustain signal, while operating in turn with the scan electrode 12A. The data electrode 20 is formed in such a way to cross the pair of the sustain electrodes 12A, 12B, and supplies a data signal for the address discharge.

An upper dielectric layer 14 and a protection film 16 are laminated on the upper substrate 10 on which the pair of the sustain electrodes 12A, 12B is formed. A lower dielectric layer 22 is formed on the lower substrate 18 on which the data electrode 20 is formed. The upper dielectric layer 14 and the lower dielectric layer 22 serve to accumulate electric charges generated by discharging. The protection film 16 serves to prevent damage of the upper dielectric layer 14 due to sputtering of plasma particles upon discharging, and improve emission efficiency of secondary electrons. The dielectric layers 14, 22 and the protection film 16 serve to low an externally inputted driving voltage.

Barrier ribs 24 are formed over the lower substrate 18 on which the lower dielectric layer 22 is formed. A phosphor layer 26 is formed on the lower dielectric layer 22 and the barrier ribs 24. The barrier ribs 24 serve to separate discharge spaces and to prevent ultraviolet generated by a gas discharge from leaking toward neighboring discharge spaces. The phosphor layer 26 is light-emitted by the ultraviolet generated by the gas discharge, producing red (R), green (G) and blue (B) visible rays. Also, an inert gas for the gas discharge is injected into the discharge spaces.

This discharge cell is selected according to the address discharge by the data electrode 20 and the scan electrode 12A. The selected discharge cell sustains its discharge with a sustain discharge by the pair of the sustain electrodes 12A, 12B. Furthermore, the discharge cell emits the phosphor layer 26 with the ultraviolet generated in the sustain discharge, so that the phosphor layer 26 emits the R, G and B visible rays. In this case, the discharge cell implements the gray scale necessary for image display by controlling a sustain discharge period, i.e., the number of sustain discharges according to video data. Moreover, a combination of three discharge cells on which the R, G and B phosphors 26 are respectively coated implements the colors of one pixel.

A representative method for driving this PDP is an ADS (Address and Display Separation) driving method in which the PDP is driven with one frame being divided into an address period and a display period, i.e., a sustain period. In the ADS driving method, one frame 1F is divided into a plurality of sub-fields SF1 to SF8 corresponding to respective bits of video data. Each of the sub-fields SF1 to SF8 is subdivided into a reset period RPD for initializing a discharge cell, an address period APD for selecting a discharge cell, and a sustain period SPD for maintaining discharging of a selected discharge cell. In this time, the PDP implements a corresponding gray scale in such a way that a different weight is assigned to the sustain periods SPD every sub-fields SF1 to SF8, and the sustain periods SPD are combined according to the video data.

This method of driving the PDP is mainly classified into a selective writing mode and a selective erasing mode depending upon whether a discharge cell selected by an address discharge is light-emitted.

In the selective writing mode, the whole screen is turned off in the reset period, and selected discharge cells are then turned on in the address period. Thus, in the sustain period, discharge of the discharge cells selected by the address discharge is maintained.

In such a selective writing mode, a width of a scan pulse is set to be relatively wide (for example, 3 μs), so that sufficient wall charges are formed within the discharge cells. If the width of the scan pulse is set to be wide, however, a problem arises in that the address period is set to be wide and the sustain period, which contributes to the brightness, is set to be relatively narrow.

In the selective erasing mode, after the whole screen undergoes a write discharge in the reset period to turn on the whole screen, selected discharge cells are turned off in the address period. Then, in the sustain period, only discharge cells, which are not selected by the address discharge, undergoes a sustain discharge, thus displaying an image.

In such a selective erasing mode, the width of the scan pulse is set to be relatively narrow (for example, 1 μs), so that an erase discharge is generated in the discharge cells. That is, in the selective erasing mode, the address period can be set to be short by applying the scan pulse having the narrow width. Accordingly, relatively lots of time can be allocated to the sustain period, which contributes to the brightness. However, the selective erasing mode is disadvantageous in that contrast is low because the whole screen is turned on in the reset period being a non-display period.

Furthermore, if the PDP is driven with one frame being divided into a plurality of sub-fields as in the prior art, there is a problem in that contour noise is generated. In the concrete, in each frame, the display periods and the non-display periods are distributed in various shapes due to sub-fields, which are separated depending upon respective bits of video data. Accordingly, the PDP displays an image by integrating light emitted from each of the sub-field periods. In this case, contour noise arises due to mismatch between the integral direction of light, which is assumed in the PDP, and a visual characteristic, which is recognized by the eye of a man. Moreover, contour noise increases when it has consecutive gray scales such as when the skin of a man is being displayed. For example, if gray scales light-emitted patterns of which are significantly different such as 127-128, 63-64 gray scale, 31-32 gray scale, etc. are displayed consecutively, contour noise increases.

In order to reduce such contour noise, methods such as a method of optimizing the sequence of sub-fields, a method of dividing sub-fields corresponding to the most significant bit (MSB), an equalizing pulse method, an error diffusion method and a dithering method were proposed. Of them, the equalizing pulse method, the error diffusion method and the dithering method are the most frequently used methods.

For example, in the equalizing pulse method, video data that causes contour noise is increased or decreased by using an equalizing pulse, thus compensating for the video data. In this method, however, a motion estimator is required since contour noise is related to motion. Furthermore, a memory having a large capacity, which can store a plurality of look-up tables, must be equipped because a different equalizing pulse is necessary depending upon the motion rate. Therefore, this method is disadvantageous in that it make hardware complicated.

In the error diffusion method, quantization error data of digital video data is calculated using a Floyd-Steinberg error diffusion filter, etc., the calculated error data is assigned with a different weight and are then diffused to neighboring pixels. In the error diffusion method, however, since error diffusion coefficients (i.e., weight) for neighboring pixels are set to be constant, they are repeated every line and every frame. Accordingly, this method has a problem in that an error diffusion pattern occurs due to the constant error diffusion coefficients.

The dithering method includes adding adequate noise so that contour noise is unnoticeable to the eye of a man. For example, European Patent Application No. 00250099.9 discloses a method in which three-dimensional dither patterns corresponding to a plurality of frames, a plurality of lines and a plurality of columns are repeatedly used in a PDP. The conventional dithering method, however, has a problem in that dithering noise occurs, which degrades the picture quality in specific gray scales. Furthermore, in the conventional dithering method, three-dimensional dither patterns are repeatedly used while toggling them, in spite of low gray scales and high gray scales. Therefore, there occurs a problem such as flicker when representing the low gray scales.

### SUMMARY OF THE INVENTION

Accordingly, the present invention has been made in view of the above problems, and it is an object of the present invention to provide a method and apparatus for driving a plasma display panel in which signal distortion can be minimized while reducing contour noise.

To achieve the above object, according to the present invention, there is provided a method of driving a plasma display panel, including the steps of: performing a first inverse gamma correction operation on externally inputted video data, performing a confined error diffusion operation on the first inverse gamma corrected video data within a range of a dither mask pattern of an upper gray scale, dithering the confined error diffused video data by using a plurality of dither mask patterns which are separated every gray scale and every frame, performing a second inverse gamma correction operation on the dithered video data, and mapping the second inverse gamma corrected video data to a sub-field pattern in which one frame includes one or more selective writing sub-fields and one or more selective erasing sub-fields.

According to the present invention, there is provided an apparatus for driving a plasma display panel, including: a first gamma correction unit for performing a first inverse gamma correction operation on externally inputted video data, a confined error diffusion unit for performing a confined error diffusion operation on the first inverse gamma corrected video data within a range of a dither mask pattern of an upper gray scale, a dithering unit for dithering the confined error diffused video data by using a plurality of dither mask patterns which are separated every gray scale and every frame, a second inverse gamma correction unit for performing a second inverse gamma correction operation on the dithered video data, and a sub-field mapping unit for mapping the second inverse gamma corrected video data to a sub-field pattern in which one frame includes one or more selective writing sub-fields and one or more selective erasing sub-fields.

According to the method and apparatus for driving the PDP in accordance with the present invention, inputted video data the number of bits is reduced by the error diffusion method and the dithering method is outputted to represent basic gray scales. Data of subdivided gray scales between the basic gray scales is distributed spatially and temporally through the error diffusion operation and the dithering operation.

According to the present invention, brightness, efficiency and the contrast ratio are improved and high-speed driving is accomplished.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the structure of a discharge cell of a conventional three-electrode AC surface discharge type PDP;

FIG. 2 is a view showing one frame of the conventional PDP;

FIG. 3 is a view showing one frame of a PDP according to an embodiment of the present invention;

FIG. 4 is a block diagram of an apparatus for driving a PDP according to an embodiment of the present invention;

FIG. 5 shows a data format outputted from the first gamma correction unit shown in FIG. 4;

FIG. 6 is a detailed block diagram of the error diffusion and dithering unit shown in FIG. 4;

FIG. 7 is a detailed block diagram of the confined error diffusion unit shown in FIG. 6;

FIGS. 8 and 9 are views for explaining an error diffusion method of the confined error diffusion filter shown in FIG. 7;

FIG. 10 is an example of dither mask patterns which are used for the dithering unit shown in FIG. 6;

FIG. 11 is a detailed block diagram of the dithering unit shown in FIG. 6;

FIG. 12 is a graph illustrating gray scales which are implemented by dithering among a video data processing method according to an embodiment of the present invention; and

FIG. 13 is a graph illustrating gray scales which are implemented by a confined error diffusion method and a dithering method among a video data processing method according to an embodiment of the present invention.

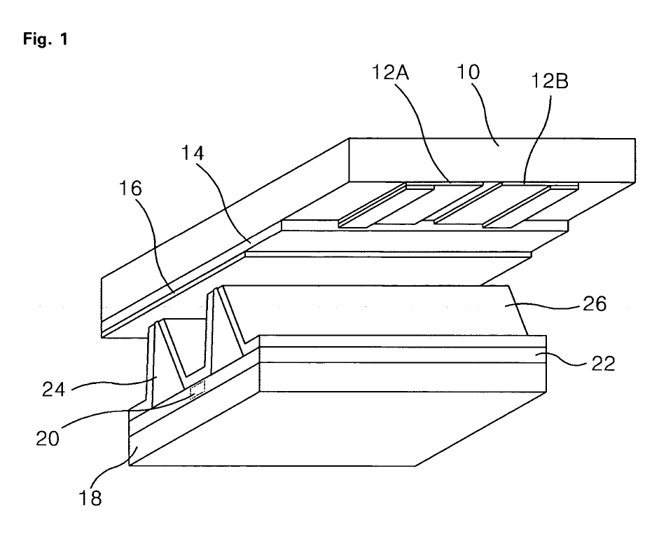

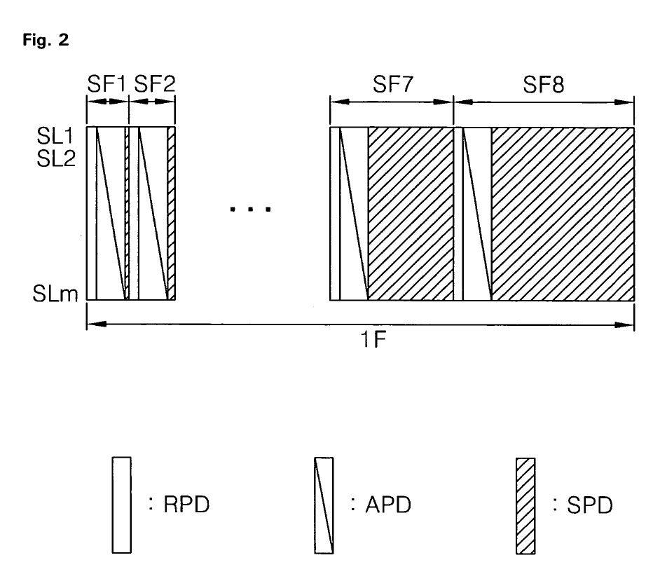

### DETAILED DESCRIPTION OF PREFERRED EMBODIMENTS

To achieve the above object, according to the present invention, there is provided a method of driving a plasma display panel, including the steps of: performing a first inverse gamma correction operation on externally inputted video data, performing a confined error diffusion operation on the first inverse gamma corrected video data within a range of a dither mask pattern of an upper gray scale, dithering the confined error diffused video data by using a plurality of dither mask patterns which are separated every gray scale and every frame, performing a second inverse gamma correction operation on the dithered video data, and mapping the second inverse gamma corrected video data to a sub-field pattern in which one frame includes one or more selective writing sub-fields and one or more selective erasing sub-fields.

In the second inverse gamma correction operation step, the inverse gamma correction operation is performed by using a gamma value, which is higher than a gamma value in the step of performing the first inverse gamma correction operation.

The first inverse gamma correction operation step includes performing the inverse gamma correction operation on the externally inputted video data by using 1.1 to 1.2 gamma curves.

The second inverse gamma correction operation step includes performing the inverse gamma correction operation so that the externally inputted video data is combined with an inverse gamma correction value resulting from the first inverse gamma correction operation step and then undergoes a 2.2 inverse gamma correction operation.

The first inverse gamma corrected data includes an integer part and a fraction part.

The number of selective erasing sub-fields included in the one frame is set to be greater than that of selective writing sub-fields included in the one frame.

The method as claimed in claim 6, wherein one of the selective writing sub-fields is included in the one frame.

The confined error diffusion operation step includes the steps of performing an error diffusion operation on lower bits of the first inverse gamma corrected video data to generate a first carry signal, comparing the first carry signal with a dither value of a position corresponding to the video data in the dither mask pattern of the upper gray scale, thus generating a second carry signal, and adding the second carry signal to upper bits of the video data and outputting the added results.

The step of generating the first carry signal comprises the step of adding random error diffusion coefficients, which are randomly set.

The dither mask patterns of the upper gray scales are selected from dither mask patterns corresponding to upper gray scales than gray scales corresponding to bits of some of the first inverse gamma corrected video data in a plurality of dither mask patterns which are previously stored.

The step of generating the second carry signal includes generating the second carry signal by performing an AND operation on the first carry signal and the selected dither value.

The dithering step includes the steps of selecting a dither mask pattern of a corresponding gray scale among the plurality of the dither mask patterns by using lower bits of some of the confined error diffused video data, selecting a dither value of a position corresponding to the confined error diffused video data among the selected dither mask pattern, and adding the selected dither value to upper bits of the remaining confined error diffused video data.

The step of selecting the dither value includes counting each of a vertical sync signal, a horizontal sync signal and a pixel clock signal all of which are inputted externally, and selecting positions corresponding to the confined error diffused video data by using the counted signals.

The dither value is selected while toggling dither mask patterns of corresponding gray scales, which are different every frame, by using the counted signal of the vertical sync signal.

According to the present invention, there is provided an apparatus for driving a plasma display panel, including: a first gamma correction unit for performing a first inverse gamma correction operation on externally inputted video data, a confined error diffusion unit for performing a confined error diffusion operation on the first inverse gamma corrected video data within a range of a dither mask pattern of an upper gray scale, a dithering unit for dithering the confined error diffused video data by using a plurality of dither mask patterns which are separated every gray scale and every frame, a second inverse gamma correction unit for performing a second inverse gamma correction operation on the dithered video data, and a sub-field mapping unit for mapping the second inverse gamma corrected video data to a sub-field pattern in which one frame includes one or more selective writing sub-fields and one or more selective erasing sub-fields.

The second inverse gamma correction unit performs the inverse gamma correction operation by using a gamma value, which is higher than a gamma value in the first inverse gamma correction unit.

The first inverse gamma correction unit and the second inverse gamma correction unit perform the inverse gamma correction operation so that the total of inverse gamma correction values of the externally inputted video data becomes 2.2 gamma.

The number of selective erasing sub-fields included in the one frame is set to be greater than that of selective writing sub-fields included in the one frame.

The confined error diffusion unit includes a dither mask select unit for selecting a dither value of a position corresponding to the first inverse gamma corrected video data from the dither mask pattern of the upper gray scale, and an error diffusion filter for performing an error diffusion operation on the first inverse gamma corrected video data to generate a first carry signal, comparing the first carry signal with the dither value to generate a second carry signal, and adding the second carry signal to the first inverse gamma corrected video data to produce confined error diffused video data.

The dither mask select unit selects one of dither mask patterns corresponding to upper gray scale than gray scales corresponding to bits of some of the inputted video data in a plurality of dither mask patterns, which is stored in the dithering unit as the dither mask pattern of the upper gray scale.

The error diffusion filter performs the error diffusion operation on lower bits of some of the first inverse gamma corrected video data to generate the first carry signal, compares the first carry signal and the dither value to generate the second carry signal, and adds the second carry signal to the remaining upper bits of the video data.

The error diffusion filter performs an AND operation on the first carry signal and the selected dither value to generate the second carry signal.

The confined error diffusion unit comprises a random error diffusion coefficient generator for generating random error diffusion coefficients, which will be added during the error diffusion operation.

The dithering unit includes a dither mask table which stores the plurality of the dither mask patterns, selects a dither value corresponding to the confined error diffused video data among the stored dither mask patterns, and outputs the selected dither value, a mask control unit that indicates a position where the dither mask table corresponds to the confined error diffused video data, and an adder for adding the dither value to the confined error diffused video data, and outputting the added results.

The dither mask table selects a dither mask pattern of a corresponding gray scale from the plurality of the dither mask patterns by using lower bits of some of the confined error diffused video data, and selects a dither value of a position corresponding to the confined error diffused video data among dither mask patterns which are selected in response to indication of the mask control unit.

The adder adds the selected dither value to the remaining upper bits of the confined error diffused video data, and outputs the added results.

The mask control unit counts a vertical sync signal, a horizontal sync signal and a pixel clock signal, respectively, which are received from the outside, and indicates a position corresponding to the confined error diffused video data by using the counted signals.

The mask control unit controls the dither mask table to select dither mask patterns of corresponding gray scales, which are different every frame, while toggling the frames, by using the counted signal of the vertical sync signal.

The mask control unit compares the confined error diffused video data with a predetermined reference value, and if the confined error diffused video data is lower than the predetermined reference value, reduces the number of the toggled frames.

Preferred embodiments of the present invention will be described in a more detailed manner with reference to the drawings.

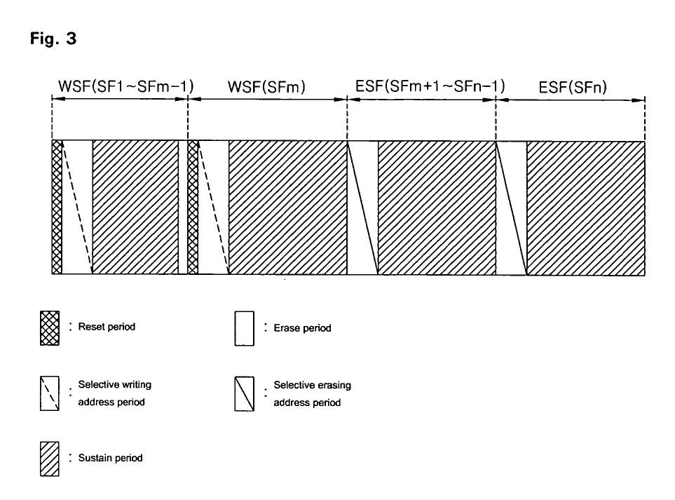

FIG. 3 is a view showing one frame of a plasma display panel according to an embodiment of the present invention.

Referring to FIG. 3, one frame of the PDP according to the present embodiment consists of a selective writing sub-field WSF having one or more sub-fields, and a selective erasing sub-field ESF having one or more sub-fields.

The selective writing sub-field WSF includes m (where, m is a positive integer greater than 0) number of sub-fields SF1 to SFm. Each of the first to (m−1)th sub-fields SF1 to SFm−1 except for the mth sub-field SFm is divided into a reset period where a constant amount of wall charges is uniformly formed in cells of the whole screen, a selective writing address period (hereinafter, referred to as writing address period) where on-cells are selected by using a write discharge, a sustain period for causing a sustain discharge in the selected on-cell to occur, and an erase period for erasing the wall charges within the cells after the sustain discharge.

The mth sub-field SFm being the last sub-field of the selective writing sub-field WSF is divided into the reset period, the writing address period and the sustain period. The reset period, the writing address period and the erase period of the selective writing sub-field WSF are the same in brightness weight every sub-fields SF1 to SFm, whereas the sustain period thereof can be the same or different in the brightness weight. In this time, the mth sub-field SFm does not include the erase period. Thus, cells, which are turned on in the mth sub-field SFm, are not erased, but keep turned on.

The selective erasing sub-field ESF includes n-m (where, n is a positive integer greater than m) number of sub-fields SFm+1 to SFn. Each of the (m+1)th to nth sub-fields SFm+1 to SFn is divided into a selective erasing address period (hereinafter, referred to as erasing address period) for selecting off-cells by using an erase discharge, and a sustain period for causing a sustain discharge to occur in on-cells. In the sub-fields SFm+1 to SFn of the selective erasing sub-field ESF, the erasing address period is set to be the same, but the sustain period is set to be the same or different depending upon a brightness relative ratio. These selective erasing sub-fields ESF represent the gray scales while selecting off-cells corresponding to data. In this case, the selective erasing sub-fields ESF can generate a discharge only in discharge cells, which are turned on in previous sub-fields.

In a method of driving the PDP according to an embodiment of the present invention, m number of sub-fields is driven in the selective writing mode, and n-m number of sub-fields is driven in the selective erasing mode, so that the address period can be set to be short and contrast can be also improved. In other words, since one frame includes the selective erasing sub-field having a short scan pulse, a sufficient sustain period can be secured. Furthermore, since one frame includes the selective erasing sub-field not having the reset period, contrast can be improved. Meanwhile, according to the present invention, the number of the selective erasing sub-fields ESF included in one frame is set to be higher than that of the selective writing sub-fields WSF. (i.e., ESF>WSF) (for example, the selective writing sub-fields WSF can be included in one frame) As such, if a number of the selective erasing sub-fields ESF are included in one frame, the amount of light generated in the reset period can be reduced and contrast can be improved accordingly. Moreover, the selective erasing sub-fields ESF are used to represent low gray scales, and the selective erasing sub-fields ESF are used to represent high gray scales.

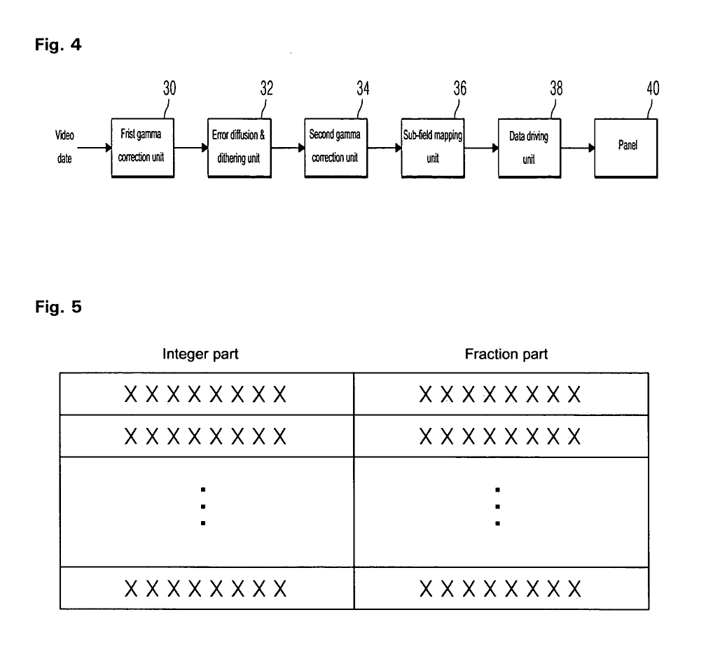

FIG. 4 is a block diagram of an apparatus for driving a plasma display panel according to an embodiment of the present invention.

Referring to FIG. 4, the apparatus for driving the PDP according to the present invention includes a first gamma correction unit 30, an error diffusion and dithering unit 32, a second gamma correction unit 34, a sub-field mapping unit 36 and a data driving unit 38 all of which are connected between an input line and a panel 40.

The first gamma correction unit 30 receives digital video data on which a gamma correction operation is performed so that it is suitable for a brightness characteristic of a cathode ray tube (CRT), i.e., video data supplied to each of discharge cells constituting the PDP. In this time, the first gamma correction unit 30 performs an inverse gamma correction operation on the video data by using a predetermined look-up table (LUT) so that the video data confirms to a 1.1 to 1.2 gamma curve. In this time, each of the video data outputted from the first gamma correction unit 30 is composed of an integer part and a fraction part, as shown in FIG. 5. In FIG. 5, X is “1” or “0”. For example, if 8-bit video data is inputted from the outside, the first gamma correction unit 30 outputs 12-bit corrected video data having a 6-bit integer part and a 6-bit fraction part, or 16-bit corrected video data having a 8-bit integer part and a 8-bit fraction part.

Meanwhile, the first gamma correction unit 30 according to the present invention carries out the inverse gamma correction operation by using the 1.1 to 1.2 gamma curve. If the inverse gamma correction operation is performed using the 1.1 to 1.2 gamma curve as such, the capability to represent low gray scales can be improved. The reason will be described in detail as follows. In a conventional PDP, externally inputted video data undergoes the inverse gamma correction operation using the 2.2 gamma curve and then experiences error diffusion and dithering processes. If the inverse gamma correction operation is performed using the 2.2 gamma curve as such, however, there is a problem in that the capability to represent low gray scales is degraded. In other words, some data of low gray scales among data on which the inverse gamma correction operation is performed using the 2.2 gamma curve are represented with gray scales of below decimal point. (e.g., 00000000.XXXXXXXX) Furthermore, since the error diffusion and dithering processes are performed using these data, the capability to represent the gray scale is degraded.

Meanwhile, in the present invention, before the error diffusion and dithering processes are performed, the inverse gamma correction operation is effected using the 1.1 to 1.2 gamma curve. Thus, data of the low gray scale has an integer part and a fraction part (e.g., 00000001.XXXXXXXX) Moreover, in the present invention, since the error diffusion and dithering processes are performed using these data, the capability to represent the gray scale can be improved.

The error diffusion and dithering unit 32 performs an error diffusion operation and a dithering operation using dither mask patterns on each of pixel data received from the first gamma correction unit 30, and then outputs pixel data the number of bits is reduced. In this case, the error diffusion and dithering unit 32 confines the effect of the error diffusion to a gray scale range of upper dither mask patterns, thereby reducing error diffusion noise and dither noise such as flicker. Detailed description on the error diffusion and dithering unit 32 will be given later on.

The second gamma correction unit 34 performs an inverse gamma correction operation on the data on which the error diffusion operation and the dithering operation are performed. In this time, the second gamma correction unit 34 carries out the inverse gamma correction operation by using a gamma value higher than that in the first gamma correction unit 30. Actually, the second gamma correction unit 34 performs the inverse gamma correction operation on received data by adding the data to an inverse gamma correction value of the first gamma correction unit 30 so that the 2.2 gamma is accomplished. That is, the second gamma correction unit 34 effects the inverse gamma correction operation so that a gamma value of data outputted therefrom become the 2.2 gamma.

The sub-field mapping unit 36 maps the video data received from the second gamma correction unit 34 to a sub-field pattern, which includes the selective writing sub-field WSF and the selective erasing sub-field ESF of one frame as shown in FIG. 3. In this time, as described above, since one frame includes the selective writing sub-field WSF and the selective erasing sub-field ESF, a sufficient sustain period can be secured and contrast can be also improved.

The data driving unit 38 latches the data received from the sub-field mapping unit 36, which is separated by the bit according to the sub-field pattern, and supplies the latched data to address electrode lines of the panel 40, on one line basis, every period where one horizontal line is driven.

The panel 40 displays given image corresponding to the data received from the data driving unit 38.

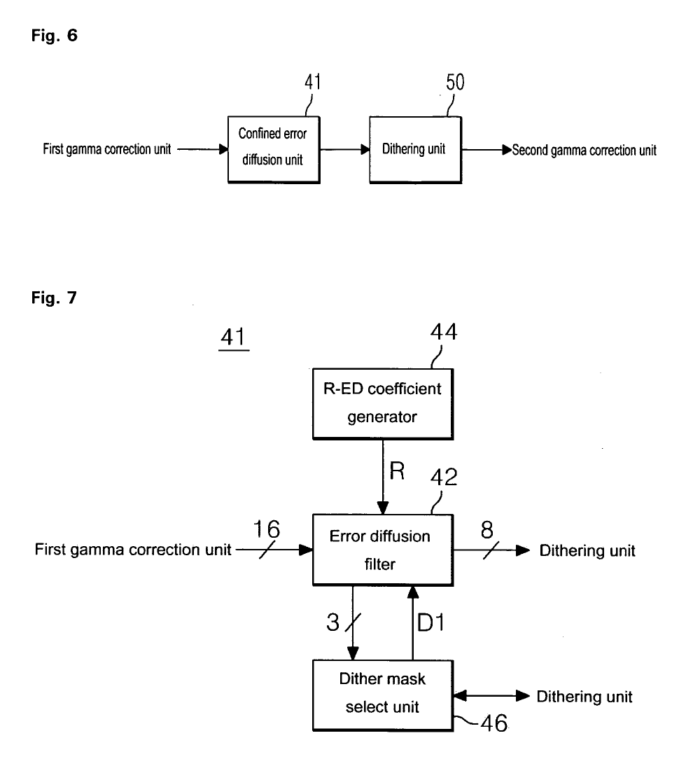

FIG. 6 is a detailed block diagram of the error diffusion and dithering unit 32 shown in FIG. 4.

Referring to FIG. 6, the error diffusion and dithering unit 32 of the present invention includes a confined error diffusion unit 41 and a dithering unit 50.

The confined error diffusion unit 41 performs the error diffusion operation on the video data received from the first gamma correction unit 30. In this time, the confined error diffusion unit 41 adds random error diffusion (hereinafter, referred to as R-ED) coefficients to the error diffusion operation so as to prevent error diffusion patterns from occurring due to constant error diffusion coefficients. Moreover, the confined error diffusion unit 41 confines the effect of the error diffusion to the range of dither mask patterns of upper gray scales by using the dither mask patterns used in the dithering unit 50.

To this end, the confined error diffusion unit 41 includes an error diffusion filter 42, and a R-ED coefficient generator 44 and a dither mask select unit 46 both of which are connected to the error diffusion filter 42, as shown in FIG. 7.

The error diffusion filter 42 includes error diffusion operators (not shown) for error diffusion, and a line memory (not shown) for storing some lower bits to be used in the error diffusion among neighboring pixel data, e.g., fraction parts. In the concrete, assuming that pixel data of 16 bits (integer part 8-bit, fraction part 8-bit) from the first gamma correction unit 30, the error diffusion filter 42 stores the 8-bit data corresponding to the fraction part among the 16 bits in the line memory so that the 8-bit data is used for the error diffusion operation of neighboring pixels. Furthermore, the error diffusion filter 42 reads the fraction parts of the neighboring pixel data, which is stored in the line memory, and assigns a different weight to the fraction parts depending upon locations of their pixels to calculate error diffusion the coefficients.

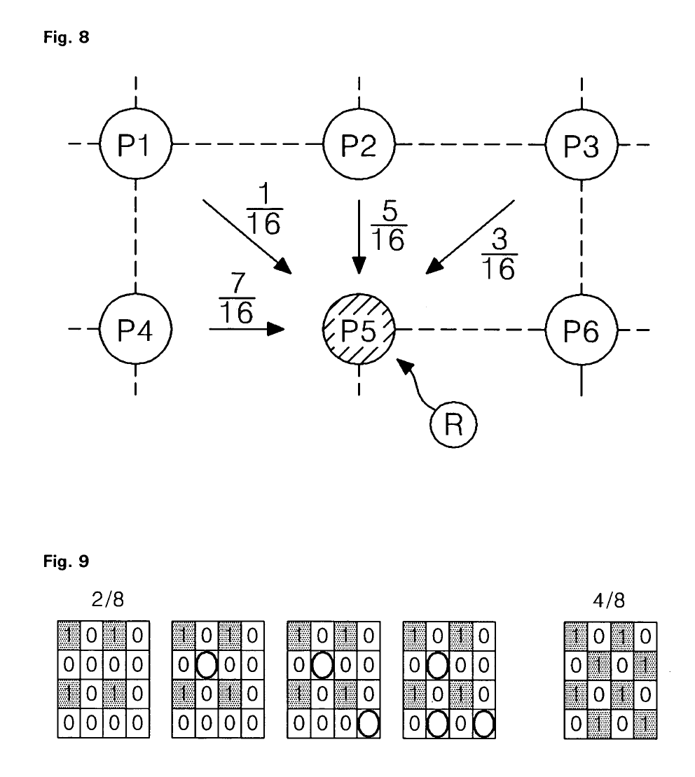

For example, the error diffusion filter 42 performs the error diffusion operation by using weights of 1/16, 5/16, 3/16 and 7/16, as shown in FIG. 8. In other words, the error diffusion filter 42 effects the error diffusion operation by assigning the weight of 1/16 to a fraction part of a pixel P1, the weight of 5/16 to a fraction part of a pixel P2, the weight of 3/16 to a fraction part of a pixel P3 and the weight of 7/16 to a fraction part of a pixel P4. The error diffusion filter 42 then carries out the error diffusion operation by multiplying a pixel P5 by the R-ED coefficients R received from the R-ED coefficient generator 44. As the random R-ED coefficients are used in the error diffusion operation as such, the error diffusion patterns can be prevented from occurring.

Furthermore, the error diffusion filter 42 confines the effect of the error diffusion to a range of the dither mask patterns of the upper gray scales among the dither mask patterns used in the dithering unit 50. In the concrete, the error diffusion filter 42 compares an initial carry signal (hereinafter, referred to as first carry signal), which is generated by the error diffusion operation performed on the current pixel data, and a dither value D1 from the dither mask select unit 46, and then outputs a last error diffusion carry signal (hereinafter, referred to as second carry signal) “0” or “1”, which will be added to upper bits of some of current pixel data, e.g., integer parts (upper 8 bits).

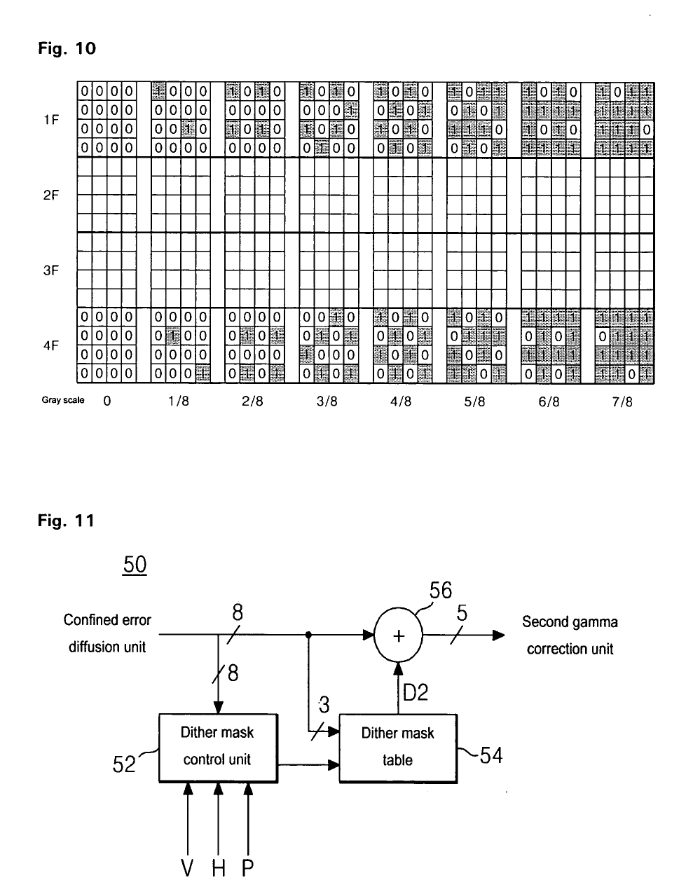

To this end, the dither mask select unit 46 selects dither mask patterns corresponding to gray scales higher than lower 3 bits, among the dither mask patterns that are stored in the dithering unit 50, by using bits of some of the current pixel data inputted to the error diffusion filter 42, e.g., the lower 3 bits of the integer parts. For example, if lower 3 bits among integer parts of currently inputted pixel data are “010”, for example, if the lower 3 bits correspond to a gray scale of 2/8 as shown in FIG. 9, a dither mask pattern corresponding to one of gray scales of ⅜ to ⅞, which are higher than the gray scale of 2/8, e.g., the gray scale of 4/8 is selected. In this case, the dither mask select unit 46 selects a dither value D1 corresponding to a current pixel data position of a current frame from dither mask patterns of four frames 1F to 4F as shown in FIG. 10, which correspond to the gray scale of 4/8 among the plurality of the dither mask patterns stored in the dithering unit 50, by using a vertical sync signal V, a horizontal sync signal H and a pixel clock signal P received from the outside, and supplies the selected the selected dither value D1 to the error diffusion filter 42.

Then, the error diffusion filter 42 compares the dither value D1, which is received from the dither mask select unit 46, with the first carry signal, which is outputted from the error diffusion, to generate the second carry signal, and adds the generated second carry signal to the integer part (upper 8 bits) of the current pixel data to produce 8-bit pixel data. In the concrete, if the first carry signal as a result of the error diffusion operation is “1” and the dither value D1 from the dither mask select unit 46 is “1”, the error diffusion filter 42 generates the second carry signal of “1”. If the first carry signal generated as a result of the error diffusion operation is not “1” and the dither value D1 from the dither mask select unit 46 is not “1”, the error diffusion filter 42 generates the second carry signal of “0”.

In other words, the error diffusion filter 42 performs an AND operation on the first carry signal outputted from the error diffusion and the dither value D1 outputted from the dither mask select unit 46 to produce the second carry signal. Accordingly, the pixel added position where the second carry signal “1” is added to pixel data due to the error diffusion in the error diffusion filter 42 is confined to the position set to 1 in the dither mask pattern of the gray scale, which is higher than the lower 3 bits, among the pixel data, as indicated by a bolt line in FIG. 9. Consequently, the effect of the error diffusion in the error diffusion filter 42 is confined to the range of the dither mask pattern of the upper gray scale. It is thus possible to minimize noise such as the flicker phenomenon due to the error diffusion.

FIG. 11 is a detailed block diagram of the dithering unit 50 shown in FIG. 6.

Referring to FIG. 11, the dithering unit 50 includes a dither mask control unit 52, a dither mask table 54 connected to the output lines of the dither mask control unit 52 and the confined error diffusion unit 41, and an adder 56 connected to the output lines of the dither mask table 54 and the confined error diffusion unit 40.

The dither mask table 54 stores different dither mask patterns every gray scale and every frame. For instance, as shown in FIG. 10, dither mask patterns having a cell (sub-pixel) size of 4×4 are separated every eight gray scales, such as 0 to ⅞, corresponding to lower 3 bits (integer parts) of pixel data, and each of the eight dither mask patterns is separated every four frames 1F to 4F. Thus, the dither mask table 54 stores a total of 32 dither mask patterns.

From FIG. 10, it can be seen that the number of cells, which are set to the dither value ″1 in each of the dither mask patterns of the gray scales 0, ⅛, 2/8, ⅜, 4/8, ⅝, 6/8, ⅞ and ⅞, increases in order of 0, 2, 4, 6, 8, 10, 12 and 14 in number.

It can be also known that the positions of the cells, which are set to the dither value 1, are different every four frames 1F to 4F. In each of the dither mask patterns, the position of “1” can vary according to a designer, if needed. The positions of on-cells corresponding to the dither value “1” can be controlled spatially and temporally depending upon these dither mask patterns. Furthermore, as the positions of the dither values “1” are different every gray scale and every frame in the dither mask patterns, dithering noise, such as grating noise caused by the repetition of constant dither mask patterns, can be reduced.

The dither mask table 54 for storing these dither mask patterns receives lower bits of some of the pixel data received from the confined error diffusion unit 41, e.g., 3 bits of 8 bit pixel data. The dither mask table 54 selects a dither mask pattern of a gray scale corresponding to the inputted lower 3 bits from the dither mask patterns such as FIG. 8. Then, the dither mask table 54 selects a dither value D2 corresponding to a frame and a cell position, which are indicated in the mask control unit 52, among the dither mask pattern of the selected gray scale, and outputs the selected dither value D2 to the added 56.

For this purpose, the dither mask control unit 52 counts the vertical sync signal V, which is received from an external controller (not shown), to indicate a corresponding frame of the four frames 1F to 4F, and counts the horizontal sync signal H and the pixel clock signal P to indicate a horizontal line and a vertical line within a corresponding frame, i.e., a cell position. In this case, the dither mask control unit 52 controls the dither mask table 54 to select a dither mask pattern of a corresponding gray scale, while toggling the first to fourth frames 1F to F4 by using the counted signal of the vertical sync signal V.

Furthermore, the dither mask control unit 52 controls the number of frames, which are toggled in the dither mask table 54, depending on a gray scale of input pixel data. In the concrete, the dither mask control unit 52 compares the pixel data from the confined error diffusion unit 41 with a predetermined reference value to determine whether the input pixel data is low gray scale data or high gray scale data. In this time, if it is determined that the input pixel data is the high gray scale data, the dither mask control unit 52 controls the dither mask table 54 to select the dither mask pattern while toggling three frames or four frames 1F to 4F, as described above. If it is determined that the input pixel data is the low gray scale data, the dither mask control unit 52 controls the dither mask table 54 to select the dither mask pattern while toggling two frames of the four frames 1F to 4F. Accordingly, if low gray scale pixel data is consistently displayed during a plurality of frames, the flicker phenomenon generating due to dither mask patterns, which are different every frame, can be prevented.

The adder 56 adds the dither value D2, which is received from the dither mask table 54, to data of upper 5 bits except for lower 3 bits among the pixel data, which is received from the confined error diffusion unit 40, as a carry signal, and then supplies the corrected 5-bit pixel data to the second inverse gamma correction unit 34. Then, the sub-field mapping unit 36 maps the data on which the inverse gamma correction operation is effected by the second inverse gamma correction unit 34 to a sub-field pattern, which includes the selective writing sub-field WSF and the selective erasing sub-field ESF of one frame, as shown in FIG. 3, and then outputs the mapped data.

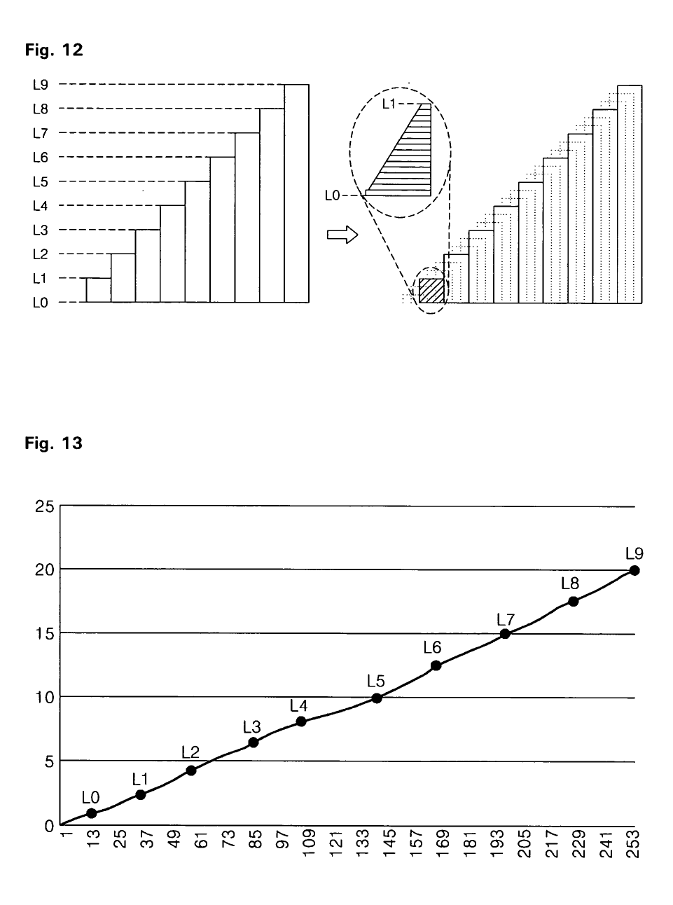

As such, according to the present invention, pixel data, which is expanded from initial 8 bits to 16 bits through the first inverse gamma correction operation, is reduced to 5-bit pixel data through the confined error diffusion operation of the confined error diffusion unit 41 and the dithering correction operation of the dithering unit 50. Thus, nine or more basic gray scales L0 to L9 can be represented using the 5-bit pixel data, as shown in FIGS. 12 and 13. Furthermore, according to the present invention, as shown in FIG. 12, the gray scales between the nine basic gray scales L1 to L9 are subdivided through the dithering correction operation using the dither mask patterns as shown in FIG. 10. Therefore, the number of the gray scales, which can be represented, can be increased. This is made possible through a combination of data 1, which are variously distributed spatially and temporally, like the dither mask patterns shown in FIG. 10.

Moreover, according to the present invention, by subdividing between-gray scales, which are subdivided through dithering correction, through confined error diffusion correction of the confined error diffusion unit 41, the number of the gray scales, which can be represented, can be further increased. In the method and apparatus for driving the PDP according to the present invention, 8-bit pixel data is reduced to 5-bit pixel data to represent nine or more basic gray scales L0 to L9, as illustrated in a brightness characteristic graph of FIG. 13, and gray scales, which are subdivided between the basic gray scales, are represented through the confined error diffusion operation and the dithering operation. Furthermore, according to the present invention, since an address time can be secured sufficiently, a PDP can be driven as a single scan (or dual scan), and linear brightness can be implemented, as shown in FIG. 13. It is thus possible to minimize contour noise due to a difference in light-emitted patterns.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method of driving a plasma display panel, comprising the steps of:
(a) performing a first inverse gamma correction operation on externally inputted video data;
(b) performing a confined error diffusion operation on the first inverse gamma corrected video data within a range of a dither mask pattern of an upper gray scale;
(c) dithering the confined error diffused video data by using a plurality of dither mask patterns, which are separated every gray scale and every frame;
(d) performing a second inverse gamma correction operation on the dithered video data; and
(e) mapping the second inverse gamma corrected video data to a sub-field pattern in which one frame includes one or more selective writing sub-fields and one or more selective erasing sub-fields.

2. The method as claimed in claim 1, wherein in the second inverse gamma correction operation step, the inverse gamma correction operation is performed by using a gamma value, which is higher than a gamma value in the step of performing the first inverse gamma correction operation.

3. The method as claimed in claim 1, wherein the first inverse gamma correction operation step includes performing the inverse gamma correction operation on the externally inputted video data by using 1.1 to 1.2 gamma curves.

4. The method as claimed in claim 3, wherein the second inverse gamma correction operation step includes performing the inverse gamma correction operation so that the externally inputted video data is combined with an inverse gamma correction value resulting from the first inverse gamma correction operation step and then undergoes a 2.2 inverse gamma correction operation.

5. The method as claimed in claim 1, wherein the first inverse gamma corrected data includes an integer part and a fraction part.

6. The method as claimed in claim 1, wherein the number of selective erasing sub-fields included in the one frame is set to be greater than that of selective writing sub-fields included in the one frame.

7. The method as claimed in claim 6, wherein one of the selective writing sub-fields is included in the one frame.

8. The method as claimed in claim 1, wherein the confined error diffusion operation step comprises the steps of:
performing an error diffusion operation on lower bits of the first inverse gamma corrected video data to generate a first carry signal;
comparing the first carry signal with a dither value of a position corresponding to the video data in the dither mask pattern of the upper gray scale, thus generating a second carry signal; and
adding the second carry signal to upper bits of the video data and outputting the added results.

9. The method as claimed in claim 8, wherein the step of generating the first carry signal comprises the step of adding random error diffusion coefficients, which are randomly set.

10. The method as claimed in claim 8, wherein the dither mask patterns of the upper gray scales are selected from dither mask patterns corresponding to upper gray scales than gray scales corresponding to bits of some of the first inverse gamma corrected video data in a plurality of dither mask patterns which are previously stored.

11. The method as claimed in claim 8, wherein the step of generating the second carry signal includes generating the second carry signal by performing an AND operation on the first carry signal and the selected dither value.

12. The method as claimed in claim 1, wherein the dithering step comprises the steps of:
selecting a dither mask pattern of a corresponding gray scale among the plurality of the dither mask patterns by using lower bits of some of the confined error diffused video data;
selecting a dither value of a position corresponding to the confined error diffused video data among the selected dither mask pattern; and
adding the selected dither value to upper bits of the remaining confined error diffused video data.

13. The method as claimed in claim 12, wherein the step of selecting the dither value includes counting each of a vertical sync signal, a horizontal sync signal and a pixel clock signal all of which are inputted externally, and selecting positions corresponding to the confined error diffused video data by using the counted signals.

14. The method as claimed in claim 13, wherein the dither value is selected while toggling dither mask patterns of corresponding gray scales, which are different every frame, by using the counted signal of the vertical sync signal.

15. An apparatus for driving a plasma display panel, comprising:
a first gamma correction unit for performing a first inverse gamma correction operation on externally inputted video data;
a confined error diffusion unit for performing a confined error diffusion operation on the first inverse gamma corrected video data within a range of a dither mask pattern of an upper gray scale;
a dithering unit for dithering the confined error diffused video data by using a plurality of dither mask patterns, which are separated every gray scale and every frame;
a second inverse gamma correction unit for performing a second inverse gamma correction operation on the dithered video data; and
a sub-field mapping unit for mapping the second inverse gamma corrected video data to a sub-field pattern in which one frame includes one or more selective writing sub-fields and one or more selective erasing sub-fields.

16. The apparatus as claimed in claim 15, wherein the second inverse gamma correction unit performs the inverse gamma correction operation by using a gamma value, which is higher than a gamma value in the first inverse gamma correction unit.

17. The apparatus as claimed in claim 16, wherein the first inverse gamma correction unit and the second inverse gamma correction unit perform the inverse gamma correction operation so that the total of inverse gamma correction values of the externally inputted video data becomes 2.2 gamma.

18. The apparatus as claimed in claim 15, wherein the number of selective erasing sub-fields included in the one frame is set to be greater than that of selective writing sub-fields included in the one frame.

19. The apparatus as claimed in claim 15, wherein the confined error diffusion unit comprises:
a dither mask select unit for selecting a dither value of a position corresponding to the first inverse gamma corrected video data from the dither mask pattern of the upper gray scale; and
an error diffusion filter for performing an error diffusion operation on the first inverse gamma corrected video data to generate a first carry signal, comparing the first carry signal with the dither value to generate a second carry signal, and adding the second carry signal to the first inverse gamma corrected video data to produce confined error diffused video data.

20. The apparatus as claimed in claim 19, wherein the dither mask select unit selects one of dither mask patterns corresponding to upper gray scale than gray scales corresponding to bits of some of the inputted video data in a plurality of dither mask patterns, which is stored in the dithering unit as the dither mask pattern of the upper gray scale.

21. The apparatus as claimed in claim 19, wherein the error diffusion filter performs the error diffusion operation on lower bits of some of the first inverse gamma corrected video data to generate the first carry signal, compares the first carry signal and the dither value to generate the second carry signal, and adds the second carry signal to the remaining upper bits of the video data.

22. The apparatus as claimed in claim 21, wherein the error diffusion filter performs an AND operation on the first carry signal and the selected dither value to generate the second carry signal.

23. The apparatus as claimed in claim 19, wherein the confined error diffusion unit comprises a random error diffusion coefficient generator for generating random error diffusion coefficients, which will be added during the error diffusion operation.

24. The apparatus as claimed in claim 15, wherein the dithering unit comprises:
a dither mask table which stores the plurality of the dither mask patterns, selects a dither value corresponding to the confined error diffused video data among the stored dither mask patterns, and outputs the selected dither value;
a mask control unit that indicates a position where the dither mask table corresponds to the confined error diffused video data; and
an adder for adding the dither value to the confined error diffused video data, and outputting the added results.

25. The apparatus as claimed in claim 24, wherein the dither mask table selects a dither mask pattern of a corresponding gray scale from the plurality of the dither mask patterns by using lower bits of some of the confined error diffused video data, and selects a dither value of a position corresponding to the confined error diffused video data among dither mask patterns which are selected in response to indication of the mask control unit.

26. The apparatus as claimed in claim 24, wherein the adder adds the selected dither value to the remaining upper bits of the confined error diffused video data, and outputs the added results.

27. The apparatus as claimed in claim 24, wherein the mask control unit counts a vertical sync signal, a horizontal sync signal and a pixel clock signal, respectively, which are received from the outside, and indicates a position corresponding to the confined error diffused video data by using the counted signals.

28. The apparatus as claimed in claim 27, wherein the mask control unit controls the dither mask table to select dither mask patterns of corresponding gray scales, which are different every frame, while toggling the frames, by using the counted signal of the vertical sync signal.

29. The apparatus as claimed in claim 28, wherein the mask control unit compares the confined error diffused video data with a predetermined reference value, and if the confined error diffused video data is lower than the predetermined reference value, reduces the number of the toggled frames.
